(19) United States
(12) Patent Application Publication
(10) Pub. No.: US 2026/0233262 A1
(43) Pub. Date: Aug. 13, 2026

(54) Device And Adaptive Method For The Cleaning Of A Nozzle In A Fluid Dispensing System

(71) Applicant: Essemtec AG, Aesch (CH)

(72) Inventors: Rajasundar Chandran, Rombach (CH); David Plass, Schongau (CH); Irving Rodriguez, Büttikon (CH); Severin Weibel, Hochdorf (CH)

(73) Assignee: Essemtec AG, Aesch (CH)

(21) Appl. No.: 19/535,399

(22) Filed: Feb. 10, 2026

(30) Foreign Application Priority Data
Feb. 11, 2025 (EP) 25157176.6

(51) Int. Cl. B08B 5/04; B05B 15/52

(52) U.S. Cl. CPC B08B 5/04; B05B 15/52

(57) ABSTRACT

A device for the cleaning of a nozzle for dispensing fluids includes an elastomeric cleaning element. The cleaning element includes a plurality of cavities extending from an upper surface. The plurality of cavities includes a first cavity having a first set of wall surface sections and a second cavity having a second set of wall surface sections. The first set of wall surface sections includes a first section and the second set of wall surface sections includes a second section, wherein an angle between the first section and the second section in a plane parallel to the upper surface is between 10 and 80. This facilitates mechanical interaction between the nozzle to be cleaned and the wall surface sections as well as the edges between the wall surface sections and the upper surface of the cleaning element along different directions without having to rotate the nozzle about its main extension.

### CROSS REFERENCE TO RELATED APPLICATIONS

The present application claims priority from European Application No. 25157176.6 filed Feb. 11, 2025, the disclosure of which is hereby incorporated herein by reference.

### TECHNICAL FIELD

The invention relates to a device for the cleaning of a nozzle in a fluid dispensing system. It further relates to an adaptive method for the cleaning of a nozzle in a fluid dispensing system.

### BACKGROUND ART

Many automated processes involve the automated dispensing of fluids having a high viscosity including e. g. solder paste or adhesives. For this purpose, the corresponding fluid dispensing systems dispose of a dispensing nozzle (or a number of dispensing nozzles) and a mechanism to dose portions of the high viscosity fluid and eject the portions through the nozzle opening of the dispensing nozzle(s).

One area of application of such devices and methods is the manufacturing of electronic devices using surface-mount technology (SMT), where electronic components are directly soldered onto the surface of a printed circuit board (PCB). State-of-the art dispensing machines and components such as those offered by the present applicant Essemtec AG, Aesch LU, Switzerland, allow for high dispensing frequencies and a very flexible application of material. In particular, the solder paste jetting process of those machines is fast, allows for high quality precise dispensing, allows for a high flexibility of adapting to different PCB layouts, reduces material waste and is compatible with a variety of materials.

One issue that has to be under control is contamination of the nozzle opening and the surrounding regions of the nozzle. For certain solder paste materials, accumulation of solder paste material around the nozzle orifice may happen at a rather fast pace. Once the orifice is contaminated, the dispensing process and quality may become negatively impacted.

Various solutions to cope with the contamination of nozzles have been proposed. Some involve the use of vacuum to suck up residues. Others involve the direct contact of the nozzle with scraping or cleaning elements. As an example, U.S. Pat. No. 11,071,994 B2 (HKC CO LTD) relates to a cleaning device for a nozzle for dispensing photoresist. The device includes a base seat and a plurality of scrape components on the base seat. The scrape components are arranged in a straight line, and each of the scrape components has a notch at its rear end, wherein the notches match with the nozzle. During cleaning, the nozzle passes through the notches of all the scrape components in sequence and interacts with those.

However, for certain types of highly viscous liquids, in particular viscous sticky solder pastes, as well as nozzle geometries, the presently available methods do not sufficiently remove the residues. Also, it could be observed that the cleaning efficiency is reduced when the solder paste dries up at the nozzle tip and this in turn leads to a faster pace of nozzle accumulation affecting the dispensing quality.

### DISCLOSURE OF THE INVENTION

The object of the invention is therefore to provide a device for the cleaning of a nozzle for dispensing fluids that improves the removal of highly viscous and sticky residues.

The solution to the problem is defined by the features of claim 1. According to the invention, the device comprises an elastomeric cleaning element, wherein
the cleaning element comprising a plurality of cavities extending from an upper surface,
the plurality of cavities comprising a first cavity having a first set of wall surface sections, and
the plurality of cavities comprising a second cavity having a second set of wall surface sections,
   wherein the first set of wall surface sections includes a first section and the second set of wall surface sections includes a second section, wherein an angle between the first section and the second section in a plane parallel to the upper surface is between 1° and 80°.

In particular, the upper surface is a planar surface. Nevertheless, it may be a convex or concave curved surface or a surface having several regions that are inclined or step one with respect to another.

Preferably, the cavities extend through the entire cleaning element. This allows for the cleaning of the cavities or the removal of residues accumulated in a cavity from the rear side of the cleaning element. The shape of the cavities is in particular prismatic, i. e. the cross-section of the cavity is constant along their extension. The wall surface sections of the cavities extend from the upper surface along the extension of the respective cavities. In particular, they extend perpendicular to the upper surface. The sections may be planar or curved, wherein a given cavity may include planar as well as curved sections.

The cavities may include closed cavities, i. e. completely surrounded by the upper surface of the cleaning element. As well, they may include open cavities, i. e. cavities that are not completely surrounded by the upper surface but open to an outer or inner contour of the cleaning element. As well, the cavities may be formed between elements (e. g. wiper-like elements) protruding over the upper surface.

The angle between the first section and the second section in a plane parallel to the upper surface designates the smallest angle enclosed between planar surfaces defined by the two sections, i. e. by definition this angle is always between 0 and 90°. If a section is curved at a given location, the corresponding planar surface is the tangent surface at this location.

According to the invention, the angle between certain wall surface sections of different cavities is between 1° and 80°, i. e. non-perpendicular. This allows for mechanical interaction between the nozzle to be cleaned and the wall surface sections as well as the edges between the wall surface sections and the upper surface of the cleaning element along different directions without having to rotate the nozzle about its main extension, just by moving the nozzle along linear axes with respect to the cleaning element. Therefore, taking into account that nozzles of a dispensing apparatus are usually movable along three Cartesian axes, the cleaning result may be improved without having to provide additional degrees of freedom.

In a preferred method for cleaning a nozzle using the device according to the invention, the nozzle is moved relative to the stationary cleaning element along a trajectory shaped in such a way that a distal portion of the nozzle contacts a plurality of wall sections of the plurality of cavities in succession in order to scrape off residues from the distal portion of the nozzle.

In particular, the trajectory includes movements along three Cartesian axes and excludes rotation of the nozzle. Due to the specific geometry of the cleaning element, the nozzle can be reliably and evenly cleaned. Nevertheless, trajectories which include rotation and/or swiveling movements of the nozzle are also possible if the nozzle has such degrees of freedom. In order to ensure that the nozzle correctly interacts with the geometry of the cleaning element the trajectory may be controlled based on laser height measurements and/or camera images of the cleaning element and/or the nozzle, in particular the distal portion of the nozzle.

The inventive device and method provide for an improved removal of residues. The device is particularly well suited to clean nozzles that are used to dispense fluids with a high viscosity, such as solder paste for the surface mounting of electronic components, highly viscous adhesives, etc. The nozzles may have various kinds of geometries, from needle-shaped nozzles with a very thin material portion surrounding the dispensing orifice to nozzles that are constituted by an orifice in a comparably solid material portion. Similarly, nozzles made from different materials, including metals and compounds, may be cleaned. The purpose of cleaning the nozzle is the removal of fluid residues (including solidified residues) from the orifice as well surrounding surface areas of the nozzle.

The device may be fully integrated into dedicated dispensing machines as well as all-in-one machines capable of pick and place of components, soldering and inspection.

Preferably, a maximum difference between two successive values of angular orientations in an ordered set of angular orientations of all wall surface sections of the plurality of cavities is 45°, more preferably 200 or less, in particular 100 or less.

This ensures that the nozzle may be contacted along several directions, wherein an angle between neighboring directions never exceeds the respective value. Therefore, residues may be reliably removed from the nozzle.

The angular orientation is defined by an angle of a line of intersection of the wall surface section with the upper surface with respect to a given fixed reference direction in the plane of the upper surface. Again, if the wall surface section is curved at a given location, it is represented by their tangent surface at this location.

In advantageous embodiments, the plurality of cavities are arranged in a rotationally symmetric pattern. This means that the volumes corresponding to the plurality of cavities may be transformed into each other by a rotation about a common central axis. This allows for a particularly simple nozzle trajectory in the cleaning process and ensures that the nozzle is cleaned evenly along all directions.

In such cases, the trajectory used in the method for cleaning preferably includes a section wherein the distal portion of the nozzle is moved along a circular path to bring it into contact with wall sections of a plurality of the cavities arranged in the rotationally symmetric pattern. In particular, a movement perpendicular to the upper surface is superimposed to the movement along the circular path, synchronized with the geometry of the successive cavities along the circular path. Whereas the trajectory may include rotation of the nozzle about its longitudinal extension, in principle no rotation of the nozzle about its longitudinal extension is required. The circular path may extend over an entire circle or an arc. The trajectory may designed in such a way that only a subset of cavities along the corresponding path interact with the nozzle.

Preferably, the plurality of cavities surround a central cavity, wherein in particular an area of the central cavity in the upper surface is larger than an area of any of the plurality of cavities in the upper surface. The central cavity allows for performing a first step of removing large portions of residue before bringing the nozzle in mechanical contact with the walls of the cavities. This first step may include the purging of the nozzle using either the dispensing media itself, using another suitable liquid and/or a pressurized gas.

In particular, the plurality of cavities are shaped as sectors of a circular ring. In particular, the sectors have the same shape and size but are rotated about the central axis. In particular, they are arranged evenly along a circle. The corresponding design provides a large number of wall sections extending along different directions and allows for an efficient and thorough removal of residues from the nozzle and surrounding surfaces.

Advantageously, the cleaning element is made from an elastomeric material having a hardness of 10-90 Shore A, in particular 20-80 Shore A. Different kinds of elastomeric materials may be used such as thermoset, thermoplastic and hybrid materials. Experiments have shown that materials having a hardness in the indicated range allow for efficient cleaning without damaging the nozzle. The specific hardness value will be chosen based on the material of the nozzle, the geometry of the nozzle, the material of the residue to be removed, the geometry of the cleaning element and/or further properties. An elastomeric material will be chosen that is durable and has good wear and tear properties.

The elastomeric cleaning element may be manufactured by any elastomeric additive manufacturing or molding technology.

Preferably, the cleaning element is removably attached to a carrier, e. g. on a plate of a dispensing or all-in-one processing machine. This allows for easily replacing the cleaning element if required.

In a group of embodiments, the cleaning element includes a first region made from a material having a first hardness and a second region made from a material having a second hardness, wherein a difference between the first hardness and the second hardness is at least 10 Shore A, in particular at least 20 Shore A.

Using a cleaning element with regions of different hardness allows for providing interaction surfaces with different hardnesses to clean different types of nozzles, to remove different kinds of residues and/or to perform different kinds of subsequent cleaning steps in a cleaning process for a given nozzle.

The regions may be constituted by different types of materials and/or the same type of material with different hardnesses. A cleaning element with regions of different hardnesses may be manufactured e. g. by co-molding or co-extrusion processes and/or assembly of several parts into the single cleaning element.

At least one of the plurality of cavities may accommodate an insert made from a material different from the material of the cleaning element, in particular from a foam material. The insert and the cleaning element may be manufactured from a same type of material but with different properties (such as hardness, density etc.). As an example, the insert may be made from a foamed portion of the same material or from a web of this material. The insert and the cleaning element may be manufactured from different types of materials, e. g. from different elastomers. In addition, the configuration of the material may be different (solid, foamed, webs etc.). As well, the insert may be constituted by a combination of different materials.

In some applications, the material of the insert is softer than that of the cleaning element. This allows for finally wiping the nozzle, especially nozzles for very sensitive applications.

In other applications, the material of the insert is harder than that of the cleaning element. For instance, the insert may provide a wiper-like section to scrap off dried solder paste that could not be removed efficiently by the interactions with the base body of the cleaning element.

Dedicated cavities may be provided for the insert(s), and/or the inserts are accommodated in cavities that otherwise serve for mechanical cleaning of the nozzle. This allows for using the same cleaning element base body in a variety of applications.

The modular approach of combining the cleaning element base body with different inserts allows for adapting the system to different application cases.

If a cleaning element with inserts is used, the trajectory preferably includes a portion in which the distal portion of the nozzle is brought into contact with the insert after or before or during contacting the plurality of wall sections. This may lead to a final step of wiping the nozzle in order to complete its cleaning, to an initial step of removing large portions of residues, etc.

In particular, the insert is mounted in the cleaning element in such a way that a portion of it protrudes over the upper surface. This allows for interaction between the insert and the distal portion of the nozzle without any interaction with the base body of the cleaning element. The cross-section of the insert may correspond to that of the cavity the insert is accommodated in and be constant over its entire length. In other embodiments, the cross-section of the insert may vary along the length of the insert. In an embodiment, the cross section in a rear portion corresponds to the geometry of the cavity in order to securely hold the insert in the cavity, whereas in a front portion, extending over the upper surface in the mounted position of the insert, the cross-section is different, such that a dedicated cleaning geometry is formed in the interaction region. The geometry of the front portion may be larger than that of the cavity, such that the insert extends over the upper surface of the cleaning element. In this way, the element can also be supported on the front surface.

In a particularly preferred implementation of the cleaning method, using a rotationally symmetric cleaning element with a central opening, the trajectory includes the following sections carried out in succession:
A) The nozzle is moved above the center of the cleaning element.
B) The nozzle is lowered (along the Z-axis) until the distal portion of the nozzle is accommodated in the central opening. (Optionally, in this position the nozzle is purged by the dispensing media itself, by another suitable liquid or pressurized gas.)
C) The nozzle is moved along the X- and/or Y-axis to bring the distal portion into contact with the sidewall of the central opening. This removes the largest part of the residues sticking to the nozzle. A movement along the Z-axis, in particular an upward movement, may be effected as well as soon as there is contact between the nozzle and the sidewall. This leads to wiping off further residue.
D) The nozzle is moved along the X-, Y- and/or Z-axis until its tip is located above the cleaning element. Subsequently, the nozzle is moved above one of the smaller cavities located radially outside of the central opening.
E) The nozzle is lowered along the Z-axis until the distal portion is accommodated in the cavity. Next, the nozzle is moved along a circular path concentric with the symmetry axis of the cleaning element. The orientation of the nozzle remains constant. Movements in Z direction are superimposed in such a way that the distal portion of the nozzle successively interacts with various sidewalls/edges of a plurality of cavities arranged along the circular path. This successively removes residue as the main direction of interaction between the nozzle and the sidewall/edge will change with each further cavity.
F) After having passed a sufficient number of cavities (in particular all cavities to ensure even cleaning of the nozzle around its circumference) the nozzle is moved up and located in the vicinity of an insert protruding over the cleaning element. The insert is comparably soft and e. g. made from a foam material or including a number of bristles. The nozzle is then moved in such a way that its distal portion contacts the protruding part of the insert, which leads to a further (and different) cleaning action.
G) Finally, the cleaned nozzle is moved away from the cleaning element and may be used for further dispensing.

In step E), the movements along the circular path and in Z direction may be controlled in such a way that only a subset of cavities along the path interact with the nozzle, e. g. only every 2^{nd} or 3^{rd} cavity. This allows for distributing the wear due to the mechanical interaction to different subsets of cavities if the starting cavity is changed from one cycle to the other and/or for using some of the cavities along the path to accommodate cleaning inserts and/or for vacuum cleaning steps (see below). In some cycles, the direction of movement along the circular path may be reversed to further distribute the wear.

The cleaning process may include the dispensing of material through the nozzle, e. g. in order to remove solidified material portions from the distal end of the orifice.

In preferred embodiments, at least one selected cavity of the plurality of cavities is connected to a vacuum source. Application of vacuum in the at least one selected cavity may be used to evacuate residues from the elastomer wiping edges and eventually free the cleaning elastomer edge for further cleaning. Application of the vacuum during the cleaning movements may improve the cleaning of the nozzle by the mechanical interaction with the cavity walls. The selected cavity may be shaped or placed differently from other cavities or may be provided with an insert or attachment changing the selected cavity's geometry.

In the cleaning method, if a selected cavity with a connection to a vacuum source is available, the trajectory preferably includes a section in which the distal portion of the nozzle is inserted into the selected cavity and vacuum is applied to the selected cavity in order to remove residues from the nozzle. In a subsequent portion of the trajectory the distal portion of the nozzle is brought into contact with the plurality of wall sections to remove remaining residues. Additionally, the distal portion of the nozzle may also be driven along the inner edges of the nozzle cavity with simultaneous or sequential vacuum aspiration to promote effective cleaning of certain sticky residues.

The airflow induced by the vacuum exerts forces onto the residues to be removed that are substantially different from forces exerted by the mechanical interaction. Therefore, due to the combination of these different types of forces, the cleaning performance is improved.

More than one vacuum cleaning step may be foreseen in a cleaning cycle, in particular alternating with the mechanical contact cleaning steps.

Preferably, a collection container for residues is arranged below the cleaning element. The collection container is adapted to collect residues removed from the nozzle by the interaction with the cleaning element. In particular, the cleaning element directly connects to cavities that extend through the entire cleaning element, from the upper surface to the lower floor. The collection container is preferably constituted by a disposable cup that is easily replaceable.

Advantageously, the vacuum source is connected to the collection container. This allows for actively sucking the residues sticking to the cavities of the cleaning element into the collection container. Therefore, the cleanliness of the cleaning element is prolonged. This is interesting especially for curable resins, adhesives, greases, viscous pastes, etc. that could have a permanent effect on the performance of the cleaning element if they accumulate. Therefore, actively sucking the residues extends the operation time until the next active cleaning step and/or replacement of the cleaning element.

In addition or instead of the vacuum connection, the device may include a cleaning function for the cleaning element, in order to remove accumulated residues. Cleaning may be effected e. g. by pressurized air or a suitable liquid. It may happen in a cleaning station into which the cleaning element may be moved or a cleaning unit is moved into a position neighboring the cleaning element. The replacement of the cleaning element as well as the cleaning step therefor may be effected fully automatically by a handling system for the cleaning element, or the cleaning element is changed and cleaned manually.

In a preferred embodiment, a shutter mechanism is arranged between the collection container and the cleaning element, the shutter mechanism being selectively adjustable between a first configuration and a second configuration, wherein in the first configuration the vacuum source is connected to only the at least one selected cavity and wherein in the second configuration the vacuum source is connected to at least some of the further cavities of the plurality of cavities. This allows for selectively using the vacuum source to interact with the nozzle accommodated by the selected cavity and to evacuate residues from further cavities. In the second configuration, the vacuum source may still be connected to the at least one selected cavity or the connection may be blocked. In contrast, in the first configuration, the vacuum connection to the further cavities will be blocked.

Alternatively, a simpler element, such as a lid, may be arranged between the collection container and the cleaning element which ensures that only the at least one selected cavity is connected to the vacuum source. In particular, the lid may include a first opening for accommodating a plug accommodated in a cavity of the cleaning element, the rear portion of which extending through the first opening into the collection container, and a second opening, which is connected to a vacuum channel leading to the surface of the lid opposed to the collection container.

In preferred implementations of the method, the trajectory comprises a section in which the distal portion of the nozzle stays accommodated in one of the plurality of cavities, the section including movements in at least a direction parallel to the upper surface of the cleaning element and in a direction perpendicular to the upper surface of the cleaning element.

Using this combination of movements, different forces are applied to different portions of the residues to be removed from the nozzle. Correspondingly, the nozzle may be reliably and evenly cleaned.

The trajectory may comprise sections in which the nozzle is moved to pass an edge of a sidewall of a cavity and the upper surface of the cleaning element. This section may involve a simultaneous synchronized movement in a plane parallel to the upper surface as well as along a direction perpendicular to it. In certain cases, in particular when the wall between the cavity and a further cavity has a low stiffness, the section may involve exclusively a movement in the plane parallel to the upper surface, i. e. the depth of the tip of the nozzle relative to the upper surface remains constant. This will lead to deforming the wall between the cavities until the tip of the nozzle enters the next cavity, at which point in time the deformed wall will spring back to its original shape.

In certain cases these cleaning steps can be performed under vacuum aspiration for better cleaning efficiency. Therefore, in particular, the trajectory comprises a section in which the distal portion of the nozzle stays accommodated in a cavity that is connected to a vacuum source. Within this section, the nozzle may be moved in any direction in order to improve the cleaning result obtained by vacuum aspiration and potentially the interaction with side walls and/or edges of the cavity.

This approach may be advantageous even in the context of a device for the cleaning of a nozzle for dispensing fluids, the device comprising an elastomeric cleaning element, which does not feature the layout of cavities according to the present invention, i. e. there is at least one cavity connected to a vacuum source and residues are removed from the distal portion of the nozzle by accommodating the nozzle in the cavity and moving the distal portion of the nozzle around within the cavity, in particular in at least a direction parallel to the upper surface of the cleaning element and in a direction perpendicular to the upper surface of the cleaning element. The movement may lead to physical interaction with the inner side walls of the cavity and/or with edges between these side walls and an upper surface of the cleaning element.

In further preferred implementations of the method, a first nozzle of a first nozzle type and a second nozzle of a second nozzle type are successively cleaned with the same cleaning element, wherein a first trajectory for cleaning the first nozzle differs from a second trajectory for cleaning the second nozzle.

Accordingly, the second nozzle will interact with different cavities and/or differently with the same or different cavities. This allows for tailoring the cleaning process for individual nozzle types. For instance, delicate long needle nozzles need a different interaction with the cleaning element than massive nozzles where the orifice is surrounded by a rather thick material portion. If nozzles are cleaned that serve to dispense different fluids, using mutually exclusive sets of cavities avoids cross contamination of the nozzles with other fluids. Accordingly, the inventive cleaning device is particularly well suited to be used in machines including two or more nozzles, in particular nozzles dispensing different fluids (e. g. solder paste, glue, etc.).

The difference in trajectories for different nozzles can include different amplitudes in the z-direction, which will lead to different contact pressures.

As well, it may be advantageous to change the trajectory in successive cleaning steps of the same nozzle (or several nozzles of the same type) as this allows to evenly distributing wear and contamination of the cleaning element. As an example, if a cleaning element is used to clean only a single nozzle and if the cleaning element is symmetric and made of a single material, the cleaning trajectory may be rotated by the angular distance between two neighboring cavities after each cleaning cycle. Similarly, the direction of a circular section of the cleaning trajectory may be reversed in order to further distribute wear and/or to interact with different regions on the nozzle.

Preferably, the trajectory is programmable and adjustable to adapt cleaning interactions to a nozzle shape and nozzle type, wherein in particular a speed and acceleration of nozzle movement and a number of passes are programmable. It is possible to provide a library of trajectories and processing parameters, which allows for selecting a suitable process matching the present task. In addition to the nozzle shape and type other criteria such as degree of contamination or the type of contaminant material may be taken into account.

The invention further relates to an adaptive method for the cleaning of a nozzle for dispensing fluids, comprising:
a) receiving data representative of a dispensing pattern to be generated by the nozzle;
b) evaluate the received data with respect to at least one contamination-promoting parameter;
c) schedule at least one cleaning cycle based on the evaluation;
d) cleaning the nozzle according to the schedule

Scheduling a cleaning cycle includes the scheduling of a cleaning cycle at a predetermined time or in a predetermined position during the process of dispensing the pattern, in particular when generating the instructions for generating the dispensing pattern from the representative data (pre-scheduling), as well as the triggering of a cleaning cycle during the dispensing process, either immediately or after a certain condition is fulfilled, e. g. the current feature of the dispensing pattern is deposited (quasi-instant).

Compared to prior art solutions for scheduling or triggering cleaning events, where a cleaning event is triggered after a fixed number of dots dispensed or after a certain elapsed process time, the number of cleaning cycles may be reduced while at the same time compliance with predetermined quality parameters is ensured (clean only when needed approach).

Compared to other prior art solutions where a cleaning cycle is triggered based on a visual inspection of the nozzle or the dispensed pattern or other means of inspection, the number of inspections during the manufacture and thus non-productive times may be reduced or inspections may even be dispensed with.

Accordingly, in both cases the net efficiency is increased.

The adaptive method is particularly preferable when used in connection with the device according to the invention. However, it can be used with other devices and methods for cleaning nozzles of fluid dispensing systems, in particular fluid dispensing systems for automated dispensing of fluids having a high viscosity such as solder paste or adhesives in a predetermined pattern.

In a most simple case, the schedule may include one or several instances when a predetermined cleaning cycle is carried out. In more advanced cases, the schedule includes information for each cleaning cycle chosen from the following:
a type of the cleaning cycle;
a duration of the cleaning cycle;
specific information characterizing the cleaning cycle (trajectory, used cleaning agents, processing parameters, etc.).

In connection with the cleaning process described above, different types of cleaning cycle may be characterized by their trajectory of the nozzle in relation to the cleaning element.

In a preferred variant of the adaptive method, cleaning cycles are scheduled to happen prior to the deposition of predetermined types of features, in particular features that are particularly prone to suffer from degradations due to nozzle contamination and/or features that lead to a considerable buildup of nozzle contamination. As an example, in a process for depositing solder paste on a PCB a pre-cleaning cycle may be scheduled prior to depositing components such as ball grid arrays (BGAs) which have turned out to be critical with respect to contamination.

It is straightforward to apply the inventive adaptive method in multi-process and multi-head applications.

In particular, the received data representative of the dispensing pattern is at least one of the following:
CAD data;
Gerber data;
the dispensing pattern itself, in a further suitable data format, e. g. as part of control data for controlling the fluid dispensing system.

Gerber data is image data according to the Gerber Format Specification (RS-274X), which is widely used in PCB fabrication. Based on the Gerber data (or CAD data) dispensing patterns for the required material layers and basically the entire processing strategy are deduced, usually in an automated process, which may happen in the context of the fluid dispensing system, e. g. on the fluid-dispensing machine itself, or in an upstream step on separate hardware. Similarly, the inventive adaptive method may be implemented on the fluid dispensing system and/or separate hardware.

The control data is in particular deduced from the initially received CAD or Gerber data. The received data may include further information relating to the deposition process, including standard processing parameters applied to a certain kind of deposition processes and/or data related to the fluid dispensing system.

Preferably, the at least one contamination-promoting parameter includes at least one of the following:
pitches between neighbouring features of the dispensing pattern;
linear speeds of the dispensing head in a plurality of segments of the dispensing pattern;
dispensing heights;
jetting frequencies;
dispensing volumes;
actuator powers.

Further parameters may be taken into account such as pressure, temperature, etc.

Experiments have shown that in particular higher pitches between neighbouring features and similarly high linear speeds of the dispensing head lead to increased nozzle contamination when processing highly viscous fluids. This is in particular due to the fact that in these situations a stream of a highly viscous thixotropic fluid tends to break up during flight, which may lead to residues adhering to the nozzle or a region surrounding the nozzle, respectively. As these parameters vary depending on the actual dispensing pattern, the adaptive method according to the invention enables a particularly well-tailored cleaning strategy which ensures compliance with quality criteria and avoids unnecessary cleaning actions.

In general, contamination of the nozzle will not be direction-independent but depend from the individual deposition pattern. This fact may be taken into account when evaluating the received data, and the cleaning cycle may be scheduled in such a way that the expected dependency on direction is taken into account. In particular, in combination with the method for cleaning the nozzle described above, the trajectory of the nozzle in the cleaning process may be chosen to increase the cleaning impact in angular regions where an increased contamination is expected.

Preferably, at least one parameter relating to the dispensed fluid is used for the scheduling of the at least one cleaning cycle, wherein the parameter relating to the dispensed fluid is chosen preferably from rheological parameters (e. g. viscosity), thixotropic properties, solvent evaporation rate and adhesiveness.

Further parameters that may be used for the scheduling of the at least one cleaning cycle relate to the setup of the dispensing assembly, e. g. the nozzle geometry and shape.

All these parameters have a considerable impact on the contamination of the nozzle, whereby a non-linear relationship may exist between the material parameters and the process parameters.

Similarly, parameters relating to the substrate to which the fluid is supplied, e. g. with respect to adhesion, may be taken into account.

In principle, for each type of dispensing process and/or kind of dispensed material, a specific set of criteria may be defined, characterizing the impact of the above mentioned (and potentially further) parameters on the probability of nozzle contamination. This set of criteria is then applied when scheduling the cleaning cycles.

Preferably, the evaluation of the received data includes the assignment of at least one cleaning index to each feature of the dispensed pattern and in that the at least one cleaning cycle is scheduled based on the assigned cleaning indices.

As mentioned above, different types, sizes and/or geometries of features (e. g. solder pads vs. ball grid arrays, BGAs) lead to different levels of nozzle contamination. Therefore, a cleaning index may be used to characterize the expected (or potential) amount of contamination due to the deposition of a certain feature. The cleaning indices of successive features may be processed, e. g. added, and as soon as a certain criterion is met, e. g. the sum has reached a certain value, a cleaning cycle is pre-scheduled or triggered. More than one cleaning index may be assigned to each of the features, wherein the plurality of cleaning indices relate to different kinds of contamination. As an example, multiple cleaning indices may be used to represent the directional dependency of the contamination. Correspondingly, different types of cleaning cycles may be scheduled depending on values obtained from processing the different sets of cleaning indices.

In a preferred embodiment, the adaptive method includes inspecting a contamination state of the nozzle and/or a deposition quality and adapting criteria for the scheduling of the at least one cleaning cycle based on the inspection result.

The inspection may include a video inspection of the nozzle and its surrounding region, and/or an inspection of the (partially) manufactured product, by video or other known means. The criteria may be adopted repeatedly and iteratively, in particular until a stable state is reached, where no further adjustment is required. This self-learning and self-improving process may be triggered again, when potentially relevant processing parameters are used that were not covered by previous self-learning phases, e. g. when a new type of feature is deposited. In principle, this approach allows for starting with a high inspection rate and triggering cleaning cycles based primarily on inspection (similar to prior art solutions) and by gradually adapting the scheduling criteria to schedule cleaning cycles when needed until no further inspection is required for the triggering of further cleaning cycles.

Further advantageous embodiments and combinations of features of the invention result from the following exemplary embodiments and the set of patent claims as a whole.

### BRIEF DESCRIPTION OF THE DRAWINGS

The drawings used to illustrate the exemplary embodiments show:

FIG. 1A an isometric view of a cleaning element according to an embodiment of the invention;

FIG. 1B a top view of the cleaning element;

FIG. 1C a bottom view of the cleaning element;

FIG. 2 a sectional view of the cleaning element arranged in a machine and interacting with a nozzle to be cleaned;

FIG. 3 a top view of the cleaning element with accommodated inserts;

FIG. 4A-H top views and sectional views of the cleaning element and the nozzle in different phases of a cleaning cycle;

FIG. 5 a flow chart of an adaptive cleaning method according to an embodiment of the invention;

FIG. 6 a chart showing an example progression of a cleaning index used in the adaptive cleaning method; and

FIG. 7 a flow chart of a self-learning adaptive cleaning method according to an embodiment of the invention.

In general, identical parts are marked with the same reference symbols in the figures.

### WAYS TO CARRY OUT THE INVENTION

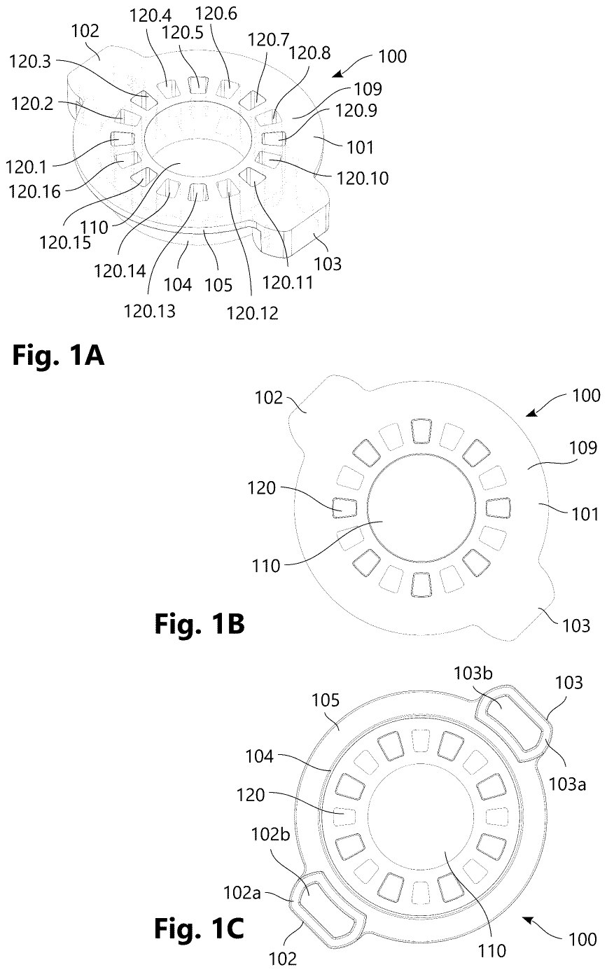

FIG. 1A is an isometric view of a cleaning element according to an embodiment of the invention, FIG. 1B is a top view and FIG. 1C is a bottom view of the cleaning element. The cleaning element 100 is made from a thermoplastic elastomer or silicone rubber with a hardness of 70 Shore A. It includes a unitary body 101 having generally the shape of a circular cylinder. Diametrically opposite to each other, two attachment sections 102, 103 are formed at the outer circumference of the body 101. The body 101 and the attachment sections 102, 103 have a common planar upper surface 109. The central cylindrical part of the body 101 features a lower portion 104 having a first diameter and a concentric flange 105 on which the upper surface 109 is formed, wherein the second diameter of the flange is larger than the first diameter.

In the body 101, a cylindrical central opening 110 is arranged extending from the upper surface 109 through the body 101 down into the lower surface. Furthermore, 16 congruent ring sector shaped cavities 120.1 . . . 120.16 are arranged around the central opening 110, wherein all neighboring cavities 120 have the same mutual distance. Like the central opening 110, the cavities 120.1 . . . 120.16 extend from the upper surface 109 through the body 101 down into the lower surface.

On the underside of the cleaning element 100, the attachment sections 102, 103 feature a rim 102a, 103a surrounding a recess 102b, 103b. The footprint of the recess 102b, 103b has roughly the shape of an elongated hexagon with rounded corners.

In the context of the embodiment, the outer diameter of the cylindrical part of the body 101 is about 50 mm, the width of flange 105 is about 5 mm. The height of the cleaning element 100 is about 10 mm.

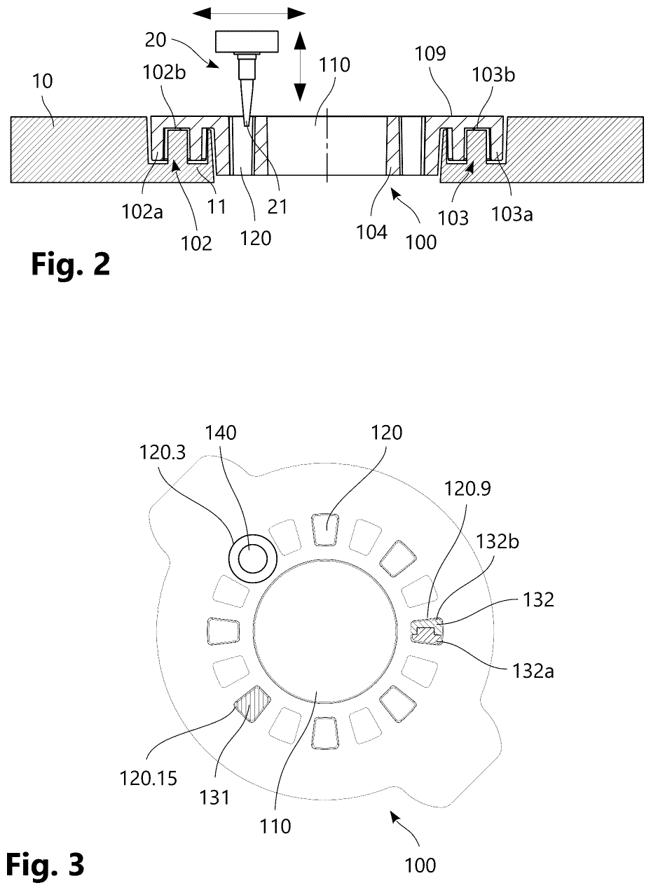

FIG. 2 is a sectional view of the cleaning element arranged in a machine and interacting with a nozzle to be cleaned. The cleaning element 100 is accommodated in a receptacle 11 arranged in a plate 10 of a machine. The receptacle 11 features a circular opening surrounded by a contour that corresponds to the outer geometry of the lower portion 104 of the cleaning element 100, including the attachment sections 102, 103 with the rims 102a, 103a and the recesses 102b, 103b. Accordingly, the cleaning element 100 may be accommodated in the plate 10 in such a way that the upper surface 109 of the cleaning element 110 is flush with the planar upper surface of the plate region surrounding the receptacle 11.

A nozzle 20 of a machine for dispensing a highly viscous liquid, e. g. solder paste for surface mounting of electronic components, is movable along three Cartesian coordinates. In the example shown in the Figures, the nozzle 20 has a narrow nozzle tip 21, but the invention is applicable to nozzles having flat sections surrounding the dispensing orifice or smaller protrusions.

The movement of the nozzle 20 may be controlled in such a way that the nozzle tip 21 may enter the central opening 110 and the cavities 120 when needed.

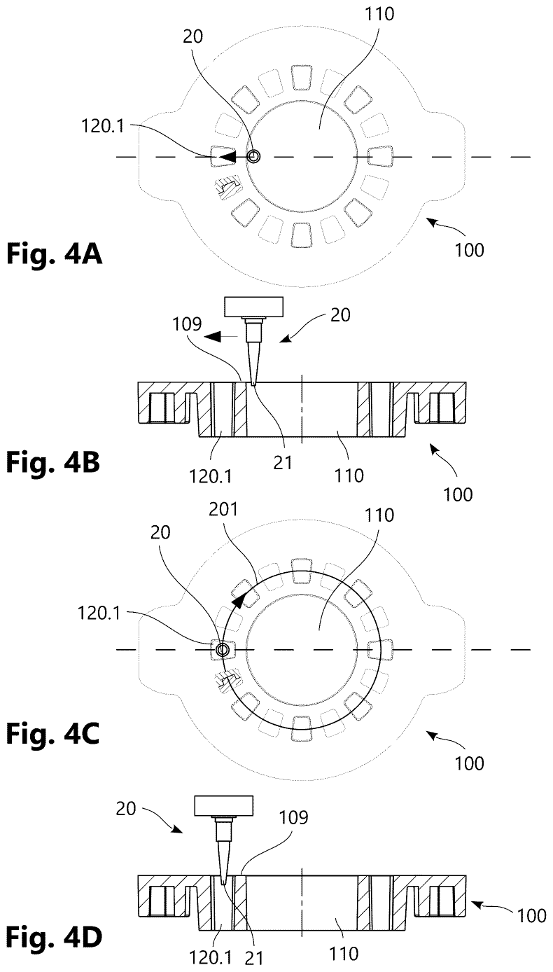

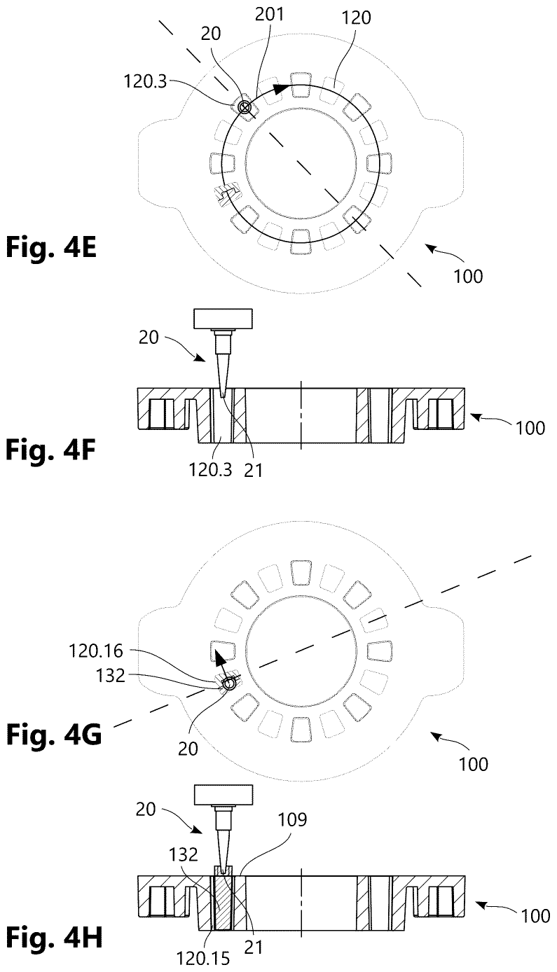

FIG. 3 is a top view of the cleaning element with accommodated inserts. In the described example, the inserts are accommodated by some of the cavities 120 arranged along the circular line surrounding the central opening 110. Specifically, a first insert 131 is accommodated in cavity 120.15. The first insert 131 has a prismatic shape, wherein the footprint corresponds to the cross section of the cavity 120.15, such that it fits within the cavity 120.15. The second insert 132 (cf. also FIG. 4H) features a base portion 132a which again is prismatic and has a footprint matching that of the opening 120.9. In contrast, the top portion 132b has a smaller footprint, such that a cleaning geometry is created. When the second insert 132 is placed in the cleaning element 100, the top portion 132b extends beyond the upper surface 109 of the cleaning element 100 (cf. also FIG. 4H).

In a further cavity 120.3, a vacuum attachment 140 is accommodated. It provides a specific geometry for introducing the nozzle tip 21, and the respective cavity 120.3 is connected to a vacuum source.

The FIG. 4A-H are used to explain a possible cleaning cycle of a nozzle 20 using the described embodiment of the cleaning element 100. The FIGS. 4A, 4C, 4E, 4G are top views showing the cleaning element 100 and the nozzle 20 in different phases of the cleaning cycle. The FIGS. 4B, 4D, 4F, 4H are sectional views showing the cleaning element 100 and the nozzle 20 in these phases. The described cycle does not include the application of vacuum and just a single insert is used. Nevertheless, the cycle may be extended by including further interactions with vacuum and/or further inserts.

First, the nozzle 20 is moved above the center of the cleaning element using the machine's mechanism for moving the nozzle 20 along the three Cartesian directions. Next, the nozzle 20 is lowered until the nozzle tip 21 is accommodated within the central opening 110 of the cleaning element 100. This situation is shown in FIGS. 4A, 4B.

Next, the nozzle 20 is moved along a linear path in a radial direction until the nozzle tip 20 contacts the edge between the wall of the central opening 110 and the upper surface 109 of the cleaning element 100. This movement is continued until the nozzle tip 21 is accommodated in a first cavity 120.1 arranged radially outside the central opening 110, cf. FIG. 4C, 4D. When passing the edge and the upper surface 109, a large part of residues of solder paste sticking to the nozzle tip 21 is removed and stays within the central opening 110.

In the next phase of the cleaning cycle, the nozzle 20 is moved along a circular path 201. The height of the nozzle 20 remains constant such that the nozzle tip 21 mechanically interacts with those sidewalls of the cavities 120 that lie in front in the direction of movement along the path 201. Due to the fact that the orientation of the nozzle 20 with the nozzle tip 21 remains constant, whereas the orientation of the cavities 120 changes, the cleaning element 100 successively interacts with several surface areas of the nozzle tip 21 and removes more and more residues step by step. FIGS. 4E and 4F show the situation when the nozzle tip 21 is accommodated in the third cavity 120.3.

After having passed all but one of the cavities 120, the nozzle 20 is moved up and located in the vicinity of the insert 132, accommodated in the 16^{th} cavity 120.16, neighboring the first cavity 120.1. The insert 132 protrudes over the upper surface 109 of the cleaning element 100. The insert is made of a foam material and thus comparably soft. The nozzle is then moved in a plane parallel to the upper surface 109 of the cleaning element 100 in such a way that its nozzle tip 21 contacts the protruding part of the insert 132, which leads to a further (and different) cleaning action (see FIG. 4G, 4H).

Finally, the cleaned nozzle 20 is moved away from the cleaning element 100 and may be used for further dispensing.

The control of the movement of the nozzle may be supported based on measurements of the absolute position of the cleaning element and its different sections and/or of the relative position of the cleaning element and its different sections with respect to the nozzle (or a nozzle carrier). These measurements may be taken e. g. using laser measuring techniques and/or video imaging.

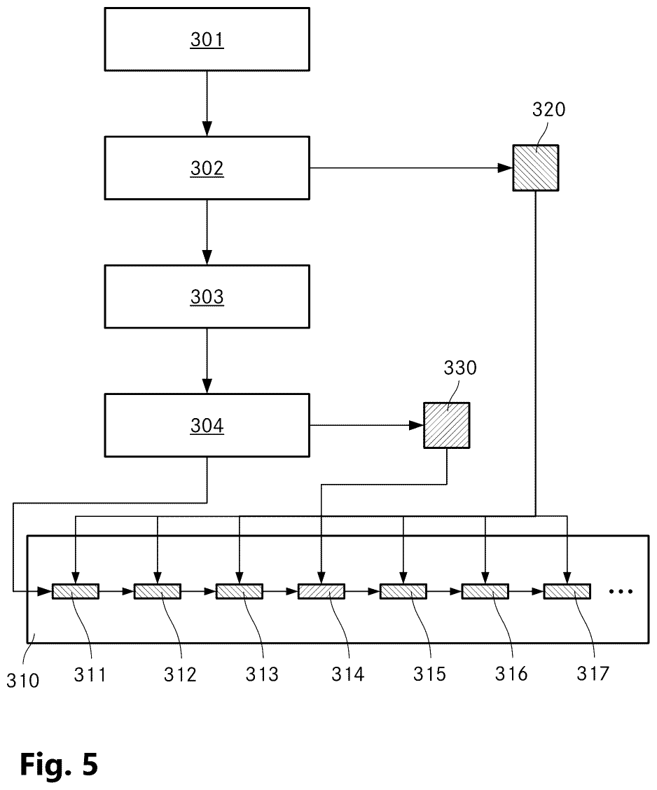

FIG. 5 is a flow chart of an adaptive cleaning method according to an embodiment of the invention. The adaptive cleaning method is part of a method for the deposition of fluid solder on a printed circuit board (PCB) using a fluid dispensing system. In a first step 301 of the described method, Gerber data representing the solder layer to be deposited is received. In a second step 302, the Gerber data is processed in a manner known as such to obtain a processing strategy 320 including information required to control the fluid dispensing system in order to obtain the solder pattern on the PCB.

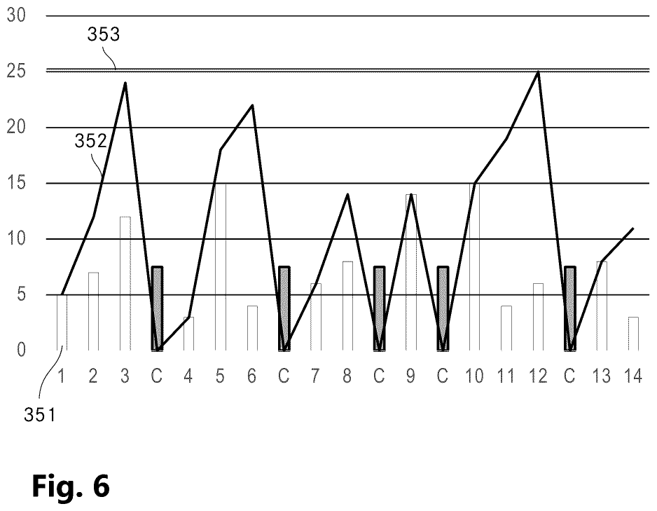

In a further step 303, the processing strategy, including the solder pattern represented by the processing strategy, is analyzed in order to obtain cleaning indices representing a measure of expected or potential contamination of a nozzle of the fluid dispensing system. This step is illustrated in connection with FIG. 6, which is a chart showing an example progression of a cleaning index used in the adaptive cleaning method. In this Figure, the chart represents the deposition of 14 features, each of which corresponds to a sub-pattern of the pattern to be deposited. To each of the features, a cleaning index 351 (vertical white bars) is assigned, based on the geometry of the respective feature as well as the associated processing parameters. In particular, the following parameters are taken into account when calculating the cleaning index:
a) dot pitch;
b) relationship with dots placed before and after;
c) dot volume;
d) dispense height;
e) jetting speed;
f) material rheology properties;
g) separation time;
h) further parameters relating to the tooling.

In principle, the features to which the cleaning indices are associated may encompass isolated elements of the pattern such as entire ball grid arrays (BGAs), subregions of such elements or even individual dots. In any case, the extent of those features should be chosen in such a way that it may be generated without any intermediate cleaning step. In the given example, a feature relates to an element of the pattern, e. g. a BGA, a solder pad or similar.

Features, the deposition of which is prone to a higher level of contamination (e. g. features 3, 5, 9, and 10) have a higher cleaning index 351 than features which are less prone to contamination.

In a further step 304, a cleaning schedule 330 is generated, based on the cleaning indices 351 obtained in the previous step 303. For this purpose, cleaning indices 351 of consecutive steps are added to obtain a cumulative cleaning index (curve 352). If the cumulative cleaning index 352 exceeds a predefined threshold 353 (a value of 25 in the described example), a cleaning step C is scheduled prior to the deposition of the feature which has caused the crossing of the threshold 353. After each cleaning step C, the cumulative cleaning index 352 is set to zero. As can be seen from FIG. 6, a cleaning step is required before deposition steps 4, 7, 9, 10, and 13, in order to ensure that the cleaning index 351 does not cross the threshold 353. This information is represented in the cleaning schedule 330.

The processing strategy 320 and the cleaning schedule 330 are then used in the actual deposition process 310 to control the sucession of steps 311 . . . 317, wherein step 314 represents a cleaning step that had been scheduled prior to step 315, i. e. deposition of feature 4.

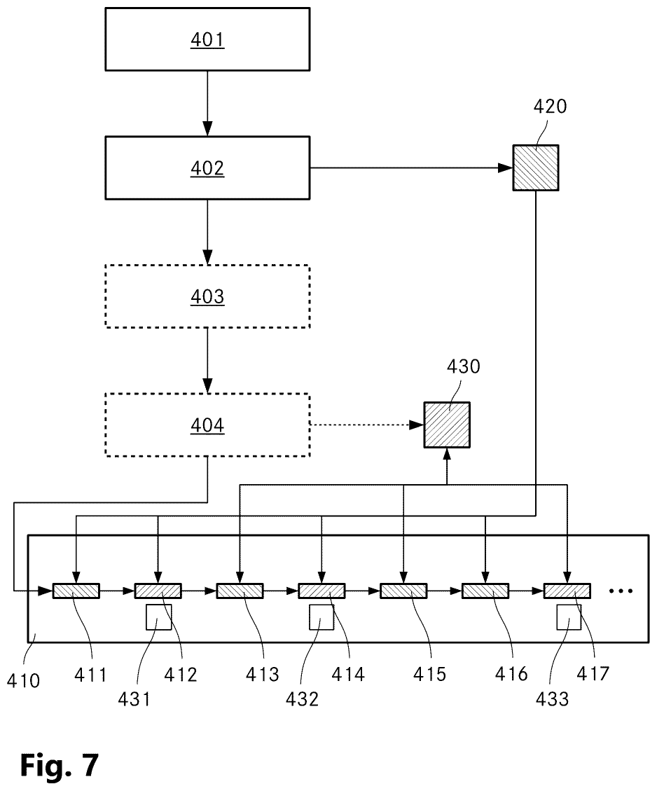

FIG. 7 is a flow chart of a self-learning adaptive cleaning method according to an embodiment of the invention. Again, this method is part of a method for the deposition of fluid solder on a printed circuit board (PCB) using a fluid dispensing system. In a first step 401 of the described method, Gerber data representing the solder layer to be deposited is received. In a second step 402, the Gerber data is processed in a manner known as such to obtain a processing strategy 420 including information required to control the fluid dispensing system in order to obtain the solder pattern on the PCB.

In further steps 403, 404, the processing strategy 420 may be analyzed and a cleaning schedule 430 may be generated, using the approach as described above, in connection with FIG. 5. Alternatively, the cleaning schedule 430 is initialized with default values.

The processing strategy 420 and the cleaning schedule 430 are then used in the actual deposition process 410 to control the sucession of steps 411 . . . 417. In contrast to the method as described above, in connection with FIG. 5, the cleaning steps include an inspection of the nozzle (or alternatively or in addition of the latest feature deposited on the PCB). If default values are used for initializing the cleaning schedule 430, they are chosen in such a way that frequent cleaning/inspection steps are foreseen in an initial phase of the processing, e. g. by assigning high cleaning indices to all feature types. As well, the default values can include cleaning indices related to feature types already known from previous deposition processes.

In the described example, a first cleaning step 412 is scheduled after the first deposition step 411. In the context of the cleaning step 412, a first inspection 431 takes place, and depending on the result of the inspection 431, a cleaning index may be assigned to the previous deposition step 411 and the cleaning schedule 430 is updated if appropriate. Actual cleaning is triggered if deemed necessary based on the first inspection 431. Due to the fact that a different feature is deposited by the following deposition step 413, another cleaning step 414 with inspection 432 takes place immediately after the following deposition step 413. Again, a new value of the cleaning index is assigned to the feature type deposited, and the cleaning schedule 430 is updated if required. Again, cleaning happens only when deemed necessary based on the inspection 432. As the cleaning index for the type of feature deposited in the next deposition step 415 has already been updated to a rather small value, no cleaning or inspection will take place immediately after this next deposition step, but only after a further deposition step 416 relating to a different, yet unknown type. In this further cleaning step 417 and the associated inspection 433, a further cleaning index is updated.

This strategy gradually leads to an improved set of cleaning indices and to a reduced frequency of cleaning steps.

The invention is not limited to the described embodiments. Many of the features of the cleaning element as well as of the steps of the cleaning method may be varied without leaving the scope of the claims. In particular, the geometry of the cleaning element may be substantially different from that of the described embodiment. Furthermore, the cleaning steps may be different or performed in a different sequence.

In summary, it can be stated that the invention provides a device for the cleaning of a nozzle for dispensing fluids that improves the removal of highly viscous and sticky residues.

### LIST OF REFERENCE SIGNS

10 plate
11 receptacle
20 nozzle
21 nozzle tip
100 cleaning element
101 body
102 attachment section
102a rim
102b recess
103 attachment section
103a rim
103b recess
104 lower portion
105 flange
109 upper surface
110 central opening
120, 120.1 . . . 16 cavity
131 insert
132 insert
132a base portion
132b top portion
140 vacuum attachment
201 path
301 step
302 step
303 step
304 step
311 step
312 step
313 step
314 step
315 step
316 step
317 step
320 processing strategy
330 cleaning schedule
351 cleaning index
352 curve
353 threshold
401 step
402 step
403 step
404 step
411 step
412 step
413 step
414 step
415 step
416 step
417 step
420 processing strategy
431 inspection
432 inspection
433 inspection
430 cleaning schedule

1. A device for the cleaning of a nozzle for dispensing fluids, the device comprising an elastomeric cleaning element,
the cleaning element comprising a plurality of cavities extending from an upper surface,
the plurality of cavities comprising a first cavity having a first set of wall surface sections,
the plurality of cavities comprising a second cavity having a second set of wall surface sections,
wherein the first set of wall surface sections includes a first section and the second set of wall surface sections includes a second section, wherein an angle between the first section and the second section in a plane parallel to the upper surface is between 1° and 80°.

2. The device according to claim 1, wherein a maximum difference between two successive values of angular orientations in an ordered set of angular orientations of all wall surface sections of the plurality of cavities is 20° or less.

3. The device according to claim 1, wherein the plurality of cavities are arranged in a rotationally symmetric pattern.

4. The device according to claim 3, wherein the plurality of cavities surround a central cavity.

5. The device according to claim 3, wherein the plurality of cavities are shaped as sectors of a circular ring.

6. The device according to claim 1, wherein the cleaning element is made from an elastomeric material having a hardness of 10-90 Shore A.

7. The device according to claim 6, wherein the cleaning element includes a first region made from a material having a first hardness and a second region made from a material having a second hardness, wherein a difference between the first hardness and the second hardness is at least 10 Shore A.

8. The device according to claim 1, wherein at least one of the plurality of cavities accommodates an insert made from a material different from the material of the cleaning element.

9. The device according to claim 8, wherein the insert protrudes over the upper surface.

10. The device according to claim 1, wherein at least one selected cavity of the plurality of cavities is connected to a vacuum source.

11. The device according to claim 1, further comprising a collection container for residues arranged below the cleaning element.

12. The device according to claim 11, further comprising a vacuum source connected to the collection container.

13. The device according to claim 12, further comprising a shutter mechanism arranged between the collection container and the cleaning element, the shutter mechanism being selectively adjustable between a first configuration and a second configuration, wherein in the first configuration the vacuum source is connected to only the at least one selected cavity and wherein in the second configuration the vacuum source is connected to at least some of the further cavities of the plurality of cavities.

14. A method for the cleaning of a nozzle for dispensing fluids using a device according to claim 1, the method comprising moving the nozzle relative to the stationary cleaning element along a trajectory shaped in such a way that a distal portion of the nozzle contacts a plurality of wall sections of the plurality of cavities in succession to scrape off residues from the distal portion of the nozzle.

15. The method according to claim 14, wherein the trajectory comprises a section in which the distal portion of the nozzle stays accommodated in one of the plurality of cavities, the section including movements in at least a direction parallel to the upper surface of the cleaning element and in a direction perpendicular to the upper surface of the cleaning element.

16. The method according to claim 14, wherein a at least one selected cavity of the plurality of cavities is connected to a vacuum source,
wherein the trajectory includes a section in which the distal portion of the nozzle is inserted into the selected cavity and vacuum is applied to the selected cavity to remove residues from the nozzle and wherein in a subsequent portion of the trajectory the distal portion of the nozzle is brought into contact with the plurality of wall sections to remove remaining residues.

17. The method according to claim 14, wherein the plurality of cavities are arranged in a rotationally symmetric pattern, and
wherein the trajectory includes a section wherein the distal portion of the nozzle is moved along a circular path to bring the nozzle into contact with wall sections of a plurality of the cavities arranged in the rotationally symmetric pattern.

18. The method according to claim 14, wherein a first nozzle of a first nozzle type and a second nozzle of a second nozzle type are successively cleaned with the same cleaning element, wherein a first trajectory for cleaning the first nozzle differs from a second trajectory for cleaning the second nozzle.

19. The method according to claim 14, wherein at least one of the plurality of cavities accommodates an insert made from a material different from the material of the cleaning element, and wherein the trajectory includes a portion in which the distal portion of the nozzle is brought into contact with the insert after or before or during contacting the plurality of wall sections.

20. The method according to claim 14, wherein the trajectory is programmable and adjustable to adapt cleaning interactions to a nozzle shape and nozzle type.

21. An adaptive method for the cleaning of a nozzle for dispensing fluids, comprising:
a) receiving data representative of a dispensing pattern to be generated by the nozzle;
b) evaluate the received data with respect to at least one contamination-promoting parameter;
c) schedule at least one cleaning cycle based on the evaluation; and
d) cleaning the nozzle according to the schedule

22. The method according to claim 21, wherein the received data is at least one of the following:
CAD data;
Gerber data; or
a dispensing pattern.

23. The method according to claim 21, wherein the at least one contamination-promoting parameter includes at least one of the following:
pitches between neighbouring features of the dispensing pattern;
linear speeds of the dispensing head in a plurality of segments of the dispensing pattern;
a dispensing height;
a jetting frequency;
a dispensing volume; or
an actuator power.

24. The method according to claim 21, wherein at least one parameter relating to the dispensed fluid is used for the scheduling of the at least one cleaning cycle

25. The method according to claim 24, wherein the parameter relating to the dispensed fluid is chosen from rheological parameters, thixotropic properties and adhesiveness.

26. The method according to claim 21, wherein the evaluation of the received data includes the assignment of at least one cleaning index to each feature of the dispensed pattern and the at least one cleaning cycle is scheduled based on the assigned cleaning indices.

27. The method according to claim 21, further comprising inspecting a contamination state of the nozzle and/or a deposition quality and adapting criteria for the scheduling of the at least one cleaning cycle based on the inspection result.
